(19) United States
(12) Patent Application Publication
(10) Pub. No.: US 2010/0107656 A1
(43) Pub. Date: May 6, 2010

(54) DEHUMIDIFIER/HUMIDIFIER FOR VEHICLE

(75) Inventors: Takanobu Nakaguro, Aichi (JP); Toshihiro Tsuemoto, Aichi (JP); Hiroyuki Kakiuchi, Kanagawa (JP); Hideto Hidaka, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi (JP)

(21) Appl. No.: 12/594,868

(22) PCT Filed: Mar. 28, 2008
(86) PCT No.: PCT/JP08/56149

§ 371 Date: Oct. 6, 2009

(30) Foreign Application Priority Data
Apr. 6, 2007 (JP) 2007-100049

(51) Int. Cl. B60H 1/00; F25B 21/02

(52) U.S. Cl. 62/3.4

(57) ABSTRACT

A dehumidifier/humidifier for vehicle comprising a casing as air flow channel and, accommodated therein in sequence, first air blower (2a), first flow channel switching unit (4a), adsorbent module (3), second flow channel switching unit (4b) and second air blower (2b). The adsorbent module (3) is built by directly disposing first adsorbent element (31) and second adsorbent element (32) on plate surfaces of Peltier element (30), respectively. By reversing the electric current flowing through the Peltier element (30) and switching the flow channel by means of the first flow channel switching unit (4a) and the second flow channel switching unit (4b), dehumidified (or humidified) air is continuously blown out from first blowout hole (11) and humidified (or dehumidified) air is continuously blown out from second blowout hole (12).

### TECHNICAL FIELD

The present invention relates to a vehicle dehumidifying/humidifying device and particularly relates to a vehicle dehumidifying/humidifying device that utilizes the adsorbing and desorbing functions of an adsorbent to supply dehumidified air for defogging to a window and supply humidified air to a passenger in winter, for example.

### BACKGROUND ART

As one vehicle cabin air conditioning technology, various dehumidification and humidification technologies that utilize the water vapor desorbing function of an adsorbent have been considered in order to make the inside of a vehicle cabin more comfortable and conserve energy. As such a technology, there has been proposed a “vehicle cabin air conditioning method” configured such that, when dry outside air from outside the cabin is introduced for window defogging and blown against the window while air is circulated inside the cabin in winter, for example, some of the airborne water that is to be discharged from the inside of the cabin to the outside of the cabin is trapped by an adsorbent such as activated carbon or a zeolite and the trapped water is returned to the inside of the cabin to thereby prevent drying inside the cabin.

In the above-described air conditioning method, the adsorbent is carried in a so-called adsorption rotor comprising an aeratable cylindrical honeycomb structure body, the adsorption rotor is rotated at a constant velocity, water is adsorbed when part of the adsorption rotor passes a predetermined adsorption region (cabin air discharge flow path), and the adsorbent is heated by air that has been heated by an electric heater and water of the adsorbent is desorbed when part of the adsorption rotor passes a predetermined desorption region (cabin air circulation flow path).
Patent Document 1: JP-A No. 2000-142096

Further, as a dehumidification and humidification technology, there has been proposed an “air conditioner” where, in order to conserve the energy of an air conditioner for cooling (a cooler) and supply comfortable air that has been dehumidified to a passenger in summer, for example, a heat exchange component and a moisture absorbing member (an adsorption rotor) are, with respect to an air flow path that has been partitioned into biserial blowing paths by a partition plate such that both ends of each of the blowing paths respectively serve as an air suction opening and an air discharge opening, sequentially disposed across the two blowing paths.

In the above-described air conditioner, air that passes through the one blowing path is cooled by the heat exchange component and air that passes through the other blowing path is heated by the heat exchange component, the moisture absorbing member is rotated or swung between the two blowing paths to repeat adsorbing and desorbing operations, and air that has been dehumidified through the one blowing path is supplied to the inside of the cabin and air that has been humidified through the other blowing path is discharged to the outside of the cabin. Further, the heat exchange component is configured by disposing a heat conducting component in a heat absorbing component and a heat releasing component of a Peltier element, air in the one blowing path is cooled by the heat conducting component of the heat absorbing component of the Peltier element and air in the other blowing path is heated by the heat conducting component of the heat releasing component of the Peltier element, whereby cold heat for promoting adsorption and hot heat needed for desorption are supplied to the moisture absorbing member.
Patent Document 2: JP-A No. 2000-146220

### DISCLOSURE OF THE INVENTION

### Problem that the Invention is to Solve

In this connection, when a vehicle dehumidifying/humidifying device is configured on the basis of a dehumidification and humidification technology such as described above that uses an adsorbent, the adsorbent is carried in a rotary member such as an adsorption rotor, and the rotary member is driven in a specific space such as the blowing paths that configure the adsorption region and the desorption region, so a rotary member drive mechanism is needed, and there is the problem that the device configuration cannot be simplified. Moreover, a casing with a capacity sufficient enough to house the rotary member and the rotary member drive mechanism is needed, and there is the problem that it is difficult to make the device compact.

Further, when a Peltier element is utilized as described above, heating and cooling of the adsorbent can be performed simultaneously in comparison to a conventional configuration that performs thermal desorption of the adsorbent with an electric heater, so the adsorption efficiency of the adsorbent can be raised. However, even when a Peltier element is utilized, the air in the blowing paths is first heated and cooled via the heat conducting components on both sides of the Peltier element, and then the adsorbent is heated and cooled via the air itself that passes through the adsorption rotor, so there are the problems that thermal efficiency is low and the Peltier element itself also becomes large in comparison to its calorific value.

Moreover, in an adsorption rotor system, the adsorbent of the adsorption rotor is cooled by air that is to be dehumidified, so the temperature of the air itself rises while the air passes through the adsorption rotor due to heat release by adsorption, and the adsorbing function is not sufficiently exhibited by the adsorbent overall, and also, the adsorbent of the adsorption rotor is heated by air that is to be humidified, so the temperature of the air itself drops while the air passes through the adsorption rotor due to heat absorption by desorption, and similarly the desorbing function cannot be sufficiently exhibited by the adsorbent overall. As a result, the aeration area must be increased and a needlessly large amount of the adsorbent must be carried, so that there is a tendency for the adsorption rotor to become large.

The present invention has been made in view of the above-described circumstances, and it is an object thereof to provide a vehicle dehumidifying/humidifying device that utilizes the adsorbing and desorbing functions of an adsorbent to supply dehumidified air for defogging to a window and supply humidified air to a passenger in winter, for example, and whose device configuration can be simplified and which device can be made compact.

### Means for Solving the Problem

In order to solve the above-described problem, in the present invention, a vehicle dehumidifying/humidifying device is configured such that an adsorbent module is configured by respectively directly disposing, on a pair of plate surfaces of a Peltier element that function as a heat absorbing component and a heat releasing component, a fixed pair of adsorbing elements that carry an adsorbent, the first adsorbing element is directly, for example, cooled by the Peltier element to promote the adsorption of an adsorbate by the adsorbent and, at the same time, the second adsorbing element is directly, for example, heated by the Peltier element to perform desorption of an adsorbate by the adsorbent, dehumidified air that has been obtained as a result of air being passed through the first adsorbing element is blown out from a first blow-out opening, and humidified air that has been obtained as a result of air being passed through the second adsorbing element is blown out to a second blow-out opening. Additionally, the vehicle dehumidifying/humidifying device is configured such that the heat absorbing component and the heat releasing component are functionally interchanged by the inversion of an electric current flowing to the Peltier element in the adsorbent module, whereby cooling and heating with respect to the adsorbing elements are switched, the adsorbing operation and the desorbing operation of the adsorbing elements are reversed, and flow path switching units are used to switch, in response to the reversal of the adsorbing operation and the desorbing operation, application destinations of air that has passed through the first adsorbing element and air that has passed through the second adsorbing element. Thus, in winter, for example, the vehicle dehumidifying/humidifying device can continuously blow out air that has been dehumidified from the first blow-out opening and can use this air for defogging a window, and the vehicle dehumidifying/humidifying device can continuously blow out air that has been humidified from the second blow-out opening and can use this air for improving the comfort of a passenger.

That is, one aspect of the present invention is a vehicle dehumidifying/humidifying device that dehumidifies and humidifies air inside a vehicle cabin, the vehicle dehumidifying/humidifying device being configured by sequentially housing a first blower, a first flow path switching unit, an adsorbent module, a second flow path switching unit and a second blower in a casing that serves as an air flow path in which a first suction opening, a second suction opening, a first blow-out opening and a second blow-out opening are disposed, wherein the adsorbent module is configured by a Peltier element equipped with a pair of plate surfaces that respectively function as a heat absorbing component and a heat releasing component and a first adsorbing element and a second adsorbing element that comprise an adsorbent carried in an aeratable element and are respectively directly disposed on the plate surfaces of the Peltier element and the adsorbent module is disposed inside the casing such that flows of air blown by the blowers are respectively capable of passing in parallel through the first adsorbing element or the second adsorbing element, the first flow path switching unit is configured to be capable of applying air that has been blown from the first blower to the first adsorbing element (or the second adsorbing element) of the adsorbent module and introducing, and applying to the second blow-out opening, air that has passed through the second adsorbing element (or the first adsorbing element) and is configured to be capable of switching the application destination of air that has been blown from the first blower and the introduction destination (introduction port) of air that is to be applied to the second blow-out opening, the second flow path switching unit is configured to be capable of introducing, and applying to the first blow-out opening, air that has passed through the first adsorbing element (or the second adsorbing element) of the adsorbent module and applying air that has been blown from the second blower to the second adsorbing element (or the first adsorbing element) and is configured to be capable of switching the introduction destination (introduction port) of air that is to be applied to the first blow-out opening and the application destination of air that has been blown from the second blower, and the vehicle dehumidifying/humidifying device is configured to blow out air that has been dehumidified (or humidified) from the first blow-out opening and blow out air that has been humidified (or dehumidified) from the second blow-out opening by inverting an electric current flowing through the Peltier element in the adsorbent module to interchange the heat absorbing component and the heat releasing component of the Peltier element and switching the first flow path switching unit and the second flow path switching unit in response to the inversion of the electric current.

### EFFECTS OF THE INVENTION

According to the vehicle dehumidifying/humidifying device of the present invention, the adsorbent module is configured by the fixed pair of adsorbing elements and the Peltier element, the adsorbing operation and the desorbing operation of the adsorbing elements are reversed by the inversion of the electric current flowing to the Peltier element, and the application destinations of the flows of air that have been dehumidified and humidified with respect to the blow-out openings are switched by the flow path switching units, so it is not necessary to dispose a rotary drive component such as in a conventional adsorption rotor, and, moreover, the adsorbing elements are directly disposed on the plate surfaces of the Peltier element that respectively function as a heat absorbing component and a heat releasing component, and thermal conductivity between the Peltier element and the adsorbing elements when heating and cooling the adsorbing elements is high, so the adsorbent module can be made even more compact and, as a result, the device configuration can be simplified and the device overall can be made even more compact.

### BRIEF DESCRIPTION OF THE DRAWINGS

FIG. 1 A block diagram showing a configural example of a vehicle dehumidifying/humidifying device pertaining to the present invention.

FIG. 2 A perspective view showing an example of an adsorbent module that is used in the vehicle dehumidifying/humidifying device pertaining to the present invention.

FIG. 3 A perspective view showing another example of the adsorbent module that is used in the vehicle dehumidifying/humidifying device pertaining to the present invention.

FIG. 4A A plan view showing the internal structure of an example of a flow path switching unit that is used in the vehicle dehumidifying/humidifying device.

FIG. 4B A side view showing the internal structure of the example of the flow path switching unit that is used in the vehicle dehumidifying/humidifying device.

FIG. 5A A front view of the flow path switching unit shown in FIGS. 4A and 4B.

FIG. 5B A rear view of the flow path switching unit shown in FIGS. 4A and 4B.

FIG. 6A A cross-sectional view broken along line B-B in FIG. 4A showing the functioning of the flow path switching unit.

FIG. 6B A cross-sectional view broken along line B-B in FIG. 4A showing the functioning of the flow path switching unit.

FIG. 7 A water vapor adsorption isotherm showing an adsorption characteristic of an adsorbent that is suitable for the vehicle dehumidifying/humidifying device of the present invention.

### BEST MODE FOR IMPLEMENTING THE INVENTION

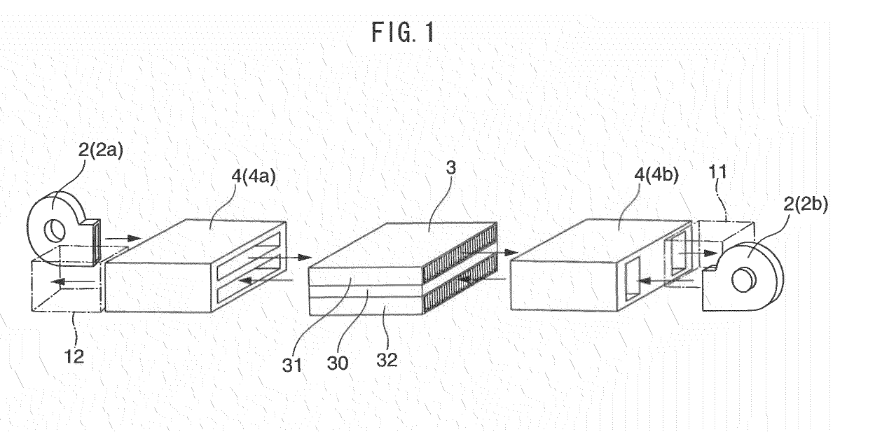

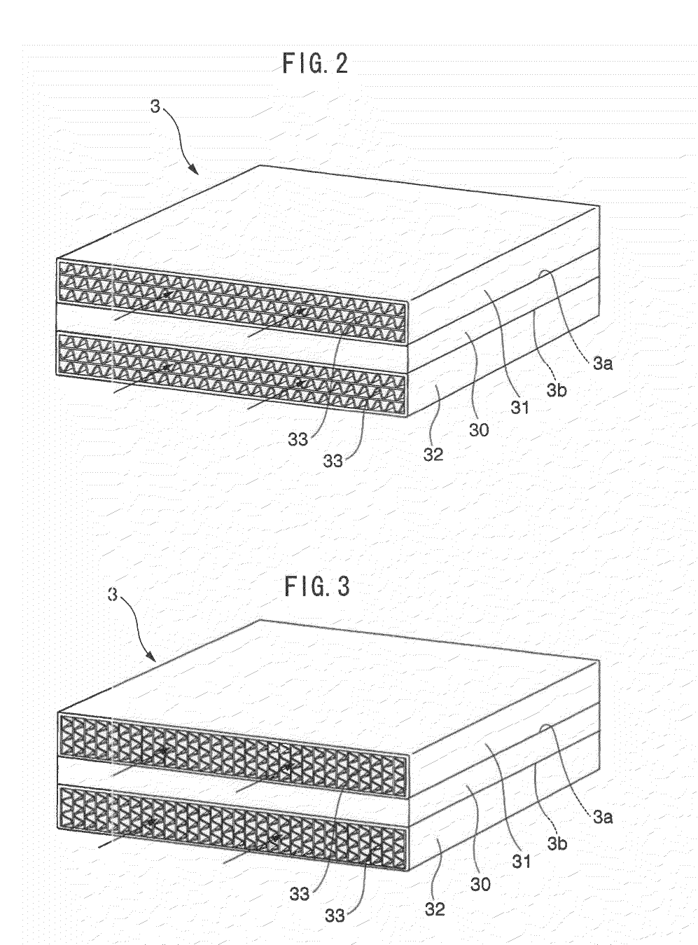

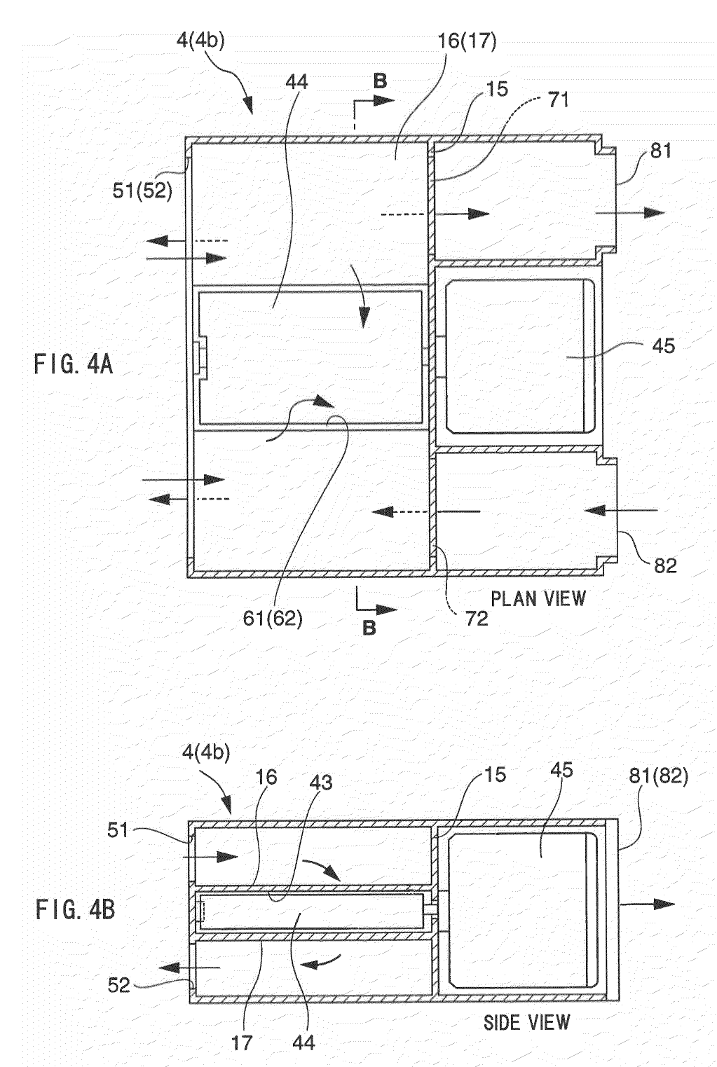

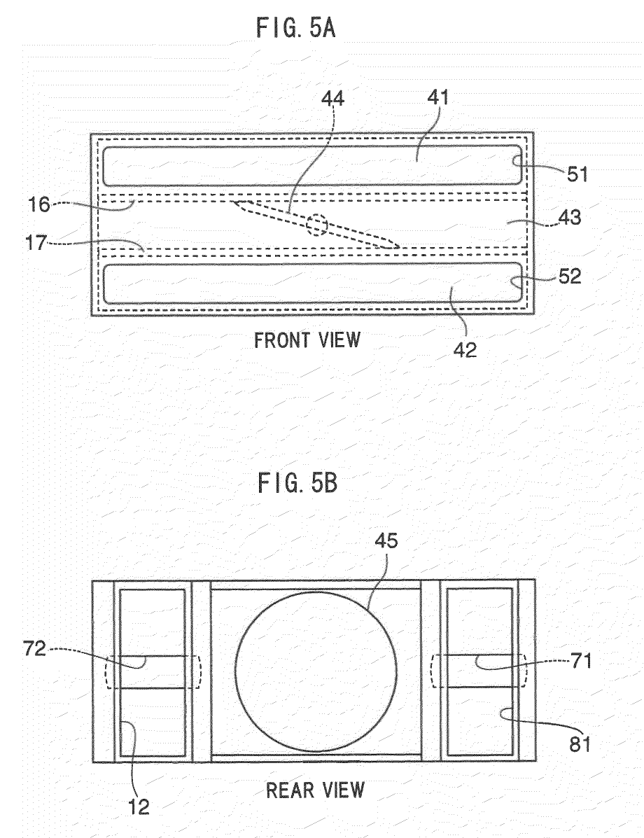

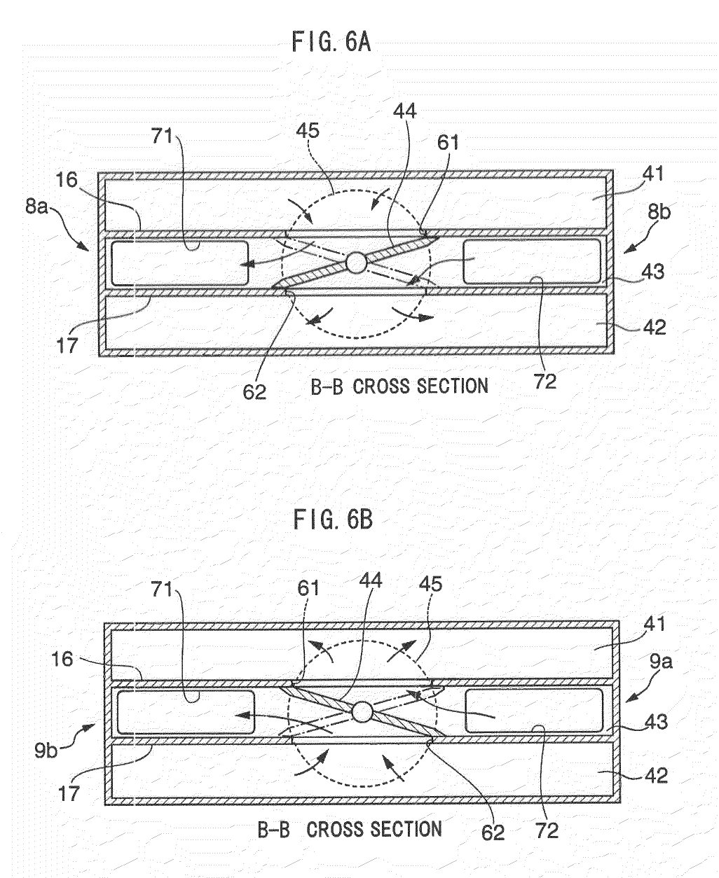

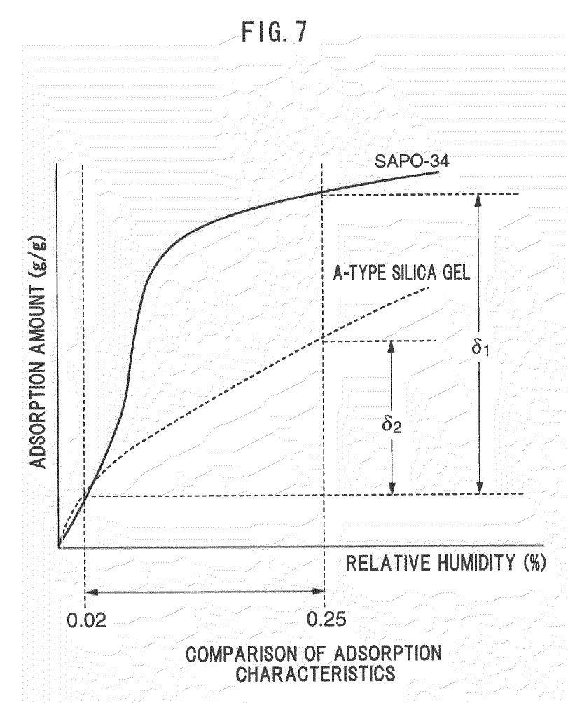

An embodiment of a vehicle dehumidifying/humidifying device pertaining to the present invention will be described on the basis of the drawings. FIG. 1 is a block diagram showing a configural example of the vehicle dehumidifying/humidifying device pertaining to the present invention. FIG. 2 and FIG. 3 are perspective views showing examples of an adsorbent module that is used in the vehicle dehumidifying/humidifying device pertaining to the present invention. FIGS. 4A and 4B are a plan view and a side view showing the internal structure of an example of a flow path switching unit that is used in the vehicle dehumidifying/humidifying device, and FIGS. 5A and 5B are a front view and a rear view of the flow path switching unit shown in FIGS. 4A and 4B. FIGS. 6A and 6B are cross-sectional views broken along line B-B in FIG. 4A showing the functioning of the flow path switching unit. Further, FIG. 7 is a water vapor adsorption isotherm showing an adsorption characteristic of an adsorbent that is suitable for the vehicle dehumidifying/humidifying device of the present invention. It will be noted that, in the description of the embodiment below, the vehicle dehumidifying/humidifying device will be abbreviated as “dehumidifying/humidifying device”.

The dehumidifying/humidifying device of the present invention is a dehumidifying/humidifying device that dehumidifies and humidifies air inside a vehicle cabin and is used in order to supply dehumidified air for defogging to a window and supply humidified air to a passenger in winter, for example, when the outside air is dry. Further, by the changing of actuation settings of later-described flow path switching units, the dehumidifying/humidifying device can also supply dehumidified air to a passenger in summer when the outside air becomes humid. Moreover, although the dehumidifying/humidifying device of the present invention can also be incorporated into an existing air conditioner, the device overall can be configured in a thin box-like shape and be installed in a ceiling portion inside a cabin as described in the embodiment below.

The dehumidifying/humidifying device of the present invention is, as shown in FIG. 1, configured by sequentially housing a first blower (2a), a first flow path switching unit (4a), an adsorbent module (3), a second flow path switching unit (4b) and a second blower (2b) in a casing (not shown) that serves as an air flow path in which a first suction opening (not shown), a second suction opening (not shown), a first blow-out opening (11) and a second blow-out opening (12) are disposed.

The casing can be designed in various shapes depending on the installation location, such as forming the outer contour shape in its thickness direction, its length direction and its width direction in a curved shape, but in order to install the casing in a ceiling, for example, as described above, the casing is formed in a flat cuboid box-like shape whose thickness portion corresponding to its height is designed thin. Additionally, two flow paths comprising an air flow path that leads from the first suction opening (e.g., the left side of the drawing) to the first blow-out opening (11) (e.g., the right side of the drawing) and an air flow path that leads from the second suction opening (e.g., the right side of the drawing) to the second blow-out opening (12) (e.g., the left side of the drawing) are configured inside the casing.

The above-described two flow paths are, for example, disposed so as to be bilaterally parallel at each end portion of the casing and are disposed so as to be vertically parallel between the flow path switching units (4) and the adsorbent module (3). Additionally, the first blower (2a), part of the first flow path switching unit (4a) and a first adsorbing element (31) of the adsorbent module (3) are, starting from the end portion of the casing on the left side of the drawing, for example, disposed in one air flow path, and the second blower (2b), part of the second flow path switching unit (4b) and a second adsorbing element (32) of the adsorbent module (3) are disposed in the other air flow path. That is, the first flow path switching unit (4a), the adsorbent module (3) and the second flow path switching unit (4b) are disposed across the two air flow paths.

Although it is not shown, the first blow-out opening (11) is, for example, connected to an existing DEF blow-out opening or a new DEF blow-out opening disposed in a dashboard, a ceiling portion or a seat, and the other second blow-out opening (12) is, for example, connected to an existing FACE center blow-out opening or a new FACE blow-out opening disposed in a dashboard, a ceiling portion or a seat. The first blow-out opening (11) and the second blow-out opening (12) may have a cross-sectional shape configured by a curve in order to reduce pressure loss. Each of the blowers (2) is a blower capable of forward and inverse rotation, and ordinarily DC centrifugal fans are used as such blowers. The number of rotations of such a centrifugal fan is about 3000 to 6000 rpm, the maximum static pressure is about 100 to 300 Pa, and the maximum flow rate is about 0.1 to 0.5 m³.

In the present invention, in order to make the device compact, there is used the specific adsorbent module (3) that does not require a drive mechanism and whose thermal efficiency is high. That is, the adsorbent module (3) is, as shown in FIG. 2, configured by: a Peltier element (30) equipped with a pair of plate surfaces that respectively function as a heat absorbing component and a heat releasing component; and a first adsorbing element (31) and a second adsorbing element (32), each of which comprises an adsorbent carried in an aeratable element (33), that are respectively directly disposed on the plate surfaces (3a) and (3b) of the Peltier element (30). Additionally, the adsorbent module (3) is disposed inside the casing such that flows of air (processed air) blown by the blowers (2) are respectively capable of passing in parallel—that is, simultaneously—through the first adsorbing element (31) and the second adsorbing element (32)

The adsorbent module (3) may be formed in a flat cuboid as shown in FIG. 2 or may be formed in a shape having a curved surface depending on the structure of the casing. Further, in the adsorbent module (3), each of the first adsorbing element (31) and the second adsorbing element (32) is configured by housing the element (33) in a metal casing in order to efficiently transmit heat (hot heat or cold heat) from the Peltier element (30) to the element (33). Moreover, it suffices for the first adsorbing element (31) and the second adsorbing element (32) to be disposed with respect to the plate surfaces (3a) and (3b) of the Peltier element (30) such that hot heat and cold heat generated by the Peltier element (30) are transmitted by heat conduction without an air layer or other heat insulating element being intervened, and the first adsorbing element (31) and the second adsorbing element (32) may be disposed via a heat conducting material such as silver paste or grease.

The Peltier element (30) is, as is well known, an element that utilizes the Peltier effect and is an electronic part that is used as a cooling device of an electronic device such as a computer. That is, the Peltier element is an element where numerous P-type semiconductors and N-type semiconductors are disposed between two types of metal plates, with a N-P junction being configured by one metal plate and a P-N junction being configured by the other metal plate, and in such an element, heat transfer occurs such that a heat absorbing phenomenon arises in one metal plate and a heat releasing phenomenon arises in the other metal plate as a result of an electric current flowing through the PN junction portion.

In the present invention, in order make the adsorbent module (3) compact, there is used the flat plate-shaped Peltier element (30), for example, whose plate surfaces (3a) and (3b) respectively function as a heat absorbing component and a heat releasing component. The power consumption of the Peltier element (30) is 1.4 to 120 W, the highest temperature of heat emission is 80 to 90° C., and the maximum temperature difference is 64 to 83° C. In the dehumidifying/humidifying device of the present invention, when designing the Peltier element (30), a heat release capacity (W1) and a heat absorption capacity (W2) demanded of the Peltier element are calculated on the basis of the following equations.

Heat release capacity(W₁)=[(specific enthalpy of humidified air [kJ/kg(DA)])−(specific enthalpy of inlet air [kJ/kg(DA)])]×(air density [kg(DA)/m³])×(flow rate of humidified air [m³/h])

Heat release capacity(W₁)=[(specific enthalpy of inlet air [kJ/kg(DA)])−(specific enthalpy of dehumidified air [kJ/kg(DA)])]×(air density [kg(DA)/m³])×(flow rate of dehumidified air [m³/h]) [Equations 1]

The unit symbol kg (DA) in the above equations represents 1 kg of dry air.

As the element (33), elements of various structures can be used as long as they can be made compact, ensure a large adsorption area and hold a large amount of powder adsorbent. Examples of the structure of the element (33) may include a so-called corrugated structure that is shown where the opening shapes of the aeration cells are formed in substantially triangular shapes by corrugated base material sheets, a honeycomb structure where the opening shapes of the aeration cells are formed in substantially hexagonal shapes, and a lattice structure where the opening shapes of the aeration cells are formed in quadrangular shapes.

For example, the corrugated element (33) is, as shown in FIG. 2, an element where numerous aeration cells are configured by alternately stacking base material sheets formed in a substantially corrugated shape and base material sheets formed in a substantially flat shape. That is, the element (33) of each of the adsorbing elements (31) and (32) has a structure where honeycomb sheets, in which one row of cells is formed by superposing a corrugated base material sheet on a flat base material sheet, are plurally adjacently disposed parallel to the plate surfaces (3a) and (3b) of the Peltier element (30), or in other words, a structure where the substantially flat base material sheet of each of the honeycomb sheets becomes parallel to the plate surfaces (3a) and (3b) of the Peltier element (30), and the aeration cells are formed such that their opening shapes on end surface sides of the element (both end surface sides in an aeration direction) are substantially triangular as a result of convex portions of the corrugated base material sheets and the adjacent flat base material sheets being joined together.

Further, the corrugated element (33) may also be configured as shown in FIG. 3. The element (33) shown in FIG. 3 has a structure where honeycomb sheets, in which one row of cells is formed by superposing a corrugated base material sheet on a flat base material sheet, are plurally adjacently disposed orthogonal to the plate surfaces (3a) and (3b) of the Peltier element (30), that is, a structure where the above-described honeycomb sheets are arrayed along the plate surfaces (3a) and (3b) of the Peltier element (30). In other words, the element (33) has a structure where the substantially flat base material sheet of each of the honeycomb sheets is disposed orthogonal to the plate surfaces (3a) and (3b) of the Peltier element (30). As described above, when elements where the honeycomb sheets of the element (33) are disposed vertically with respect to the plate surfaces (3a) and (3b) of the Peltier element (30) are used as the adsorbing elements (31) and (32), hot heat and cold heat of the Peltier element (30) can be uniformly and efficiently transmitted with respect to the honeycomb sheets configuring the element (33) of each of the adsorbing elements (31) and (32), and the heating and cooling effects resulting from the Peltier element (30) can be raised even more.

The honeycomb sheets used in the element (33) of each of the adsorbing elements (31) and (32) shown in FIG. 2 and FIG. 3 can be manufactured by a so-called honeycomb forming machine that alternately stacks two types of base material sheets with different lengths and joins them together at constant intervals while drawing the longer base material sheets; at that time, the flat base material sheets and the corrugated base material sheets that are adjacent are joined together by thermal welding, ultrasonic welding, or adhesion using an adhesive. Additionally, the element (33) is manufactured by manufacturing, by a method such as described above, corrugated honeycomb sheets, for example, comprising ceramic paper or the like as the base material sheets, stacking the honeycomb sheets to manufacture a structure body of the element, and thereafter immersing the structure body in a slurry comprising an adsorbent, a binder and a solvent. It will be noted that the honeycomb sheet manufacturing method itself is publicly known and disclosed in, for example, JP-A No. 2004-209420.

In the present invention, it is preferable for the adsorbent carried in the element (33) to have an adsorbing characteristic such as described below in order to sufficiently dehumidify air that is blown out for window defogging from the first blow-out opening (11) and effectively humidify air that is blown out toward a passenger from the second blow-out opening (12) in winter, for example.

That is, assuming that the temperature of the air circulating inside the vehicle cabin during heating in winter is 25° C., the relative humidity thereof is a relatively low humidity of about 25 to 50%, and in order to achieve a defogging effect with respect to a window of a low temperature of 5° C., for example, by the air that is blown out, it is necessary for the adsorbent to have the characteristic that the adsorbent can sufficiently adsorb water even in such a low humidity as described above and can also reduce the relative humidity of the air that is blown out to about 20% or less.

On the other hand, in regeneration of the adsorbent, the Peltier element (30) is used, and in order to reduce power consumption, it is necessary for the adsorbent to be able to desorb water at a temperature of 90° C. or lower and preferably at a relatively low temperature of 70° C. or lower. Additionally, when the inside of the vehicle cabin is in a moderately comfortable state, such as a temperature of 25° C. and a humidity of 50%, for example, the relative humidity when air passing through the element (33) has been heated to 90° C. by the Peltier element (30) becomes 2%, and the relative humidity when air passing through the element (33) has been heated to 70° C. by the Peltier element (30) becomes 4%. Consequently, it is desirable for the adsorbent to have the characteristic that the adsorbent can easily adsorb and desorb water in a range where the relative humidity is 2 to 25% and preferably a range of 4 to 25%.

Further, the adsorption and desorption amount required of the adsorbent is as described next. That is, when the air inside the vehicle cabin is to be supplied to a window for defogging, usually about 120 m³/h of air is blown out. At that time, assuming that the temperature of the window is 5° C., in order to prevent condensation on the window, it is preferable for the air that is blown out to be dehumidified to equal to or less than the absolute humidity in a saturated state of 5° C., or equal to or less than about 5 g/kg. Additionally, assuming, as mentioned before, that the temperature of the air inside the cabin is 25° C. and that the humidity of the air inside the cabin is 50%, then the absolute humidity of this air is 9.8 g/kg, so it is necessary for 120 m³/h (=15.5 kg/h) of air to be dehumidified equal to or greater than 4.8 g/kg. Consequently, it is preferable for the adsorbent to be able to adsorb 750 g/h of water, for example.

Moreover, in order to humidify the air inside the vehicle cabin and supply the humidified air to a passenger without imparting a feeling of discomfort to the passenger, for example, blowing air at a wind velocity of 1 to 2 m/s and a flow rate of 4.7 m³/h is supposed. At that time, when the temperature of the air that is sucked in is 20° C., the relatively humidity is 30% and the absolute humidity is 4.35 g/kg (DA), in order to blow out humidified air whose temperature is 25° C., whose relative humidity is 40% and whose absolute humidity is 7.91 g/kg (DA) toward the passenger, it is necessary to raise the absolute humidity by 1.82 g/kg (DA), and at the above-described flow rate, the air must be humidified a water amount of 10.3 g/h.

On the other hand, in actuation of the adsorbent module (3), as described later, the adsorbing operation and the desorbing operation by the first adsorbing element (31) and the second adsorbing element (32) are alternately switched therebetween, and assuming that the number of times that switching between the adsorbing and desorbing operations occurs is 12 times/h, in one-time adsorbing operation and desorbing operation of each of the adsorbing elements (31) and (32), it is necessary for about 0.85 g of water to be adsorbed and desorbed by the adsorbent. Moreover, in terms of practicality, it is necessary to make the adsorbing elements (31) and (32) compact in order to incorporate them in an even more compact casing, and when the effective volume in the element (33) (apparent volume in a state where the element is carrying the adsorbent) is 35 cm³, the mass of the adsorbent that can be carried in the element (33) becomes about 6 g. Consequently, an adsorption/desorption amount of at least 0.14 g/g is demanded for the adsorbent.

That is, in the present invention, it is necessary for the adsorbent carried in the adsorbing elements (31) and (32) of the adsorbent module (3) to have an adsorption characteristic where the difference between the adsorption amount at a relative humidity of 25% and the adsorption amount at a relative humidity of 2% in a water vapor adsorption isotherm of 25° C. is equal to or greater than 0.14 g/g. Preferably, it is necessary for the adsorbent to have an adsorption characteristic where the difference between the adsorption amount at a relative humidity of 25% and the adsorption amount at a relative humidity of 4% is equal to or greater than 0.14 g/g.

In the present invention, examples of adsorbents that satisfy the above-described characteristic may include zeolites, which can easily adsorb water vapor at a low humidity and can easily desorb water vapor at a low temperature. Examples of such zeolites may include FAU or other aluminosilicates whose silica-to-alumina ratio is equal to or greater than 2.5 and aluminophosphates; in particular, crystalline aluminophosphates including at least Al and P in a framework structure are preferable. From the standpoint of raising the diffusion of water vapor in the individual particles of the adsorbent, the size (average particle diameter) of the particles of the adsorbent is ordinarily 0.1 to 300 μm, preferably 0.5 to 250 μm, more preferably 1 to 200 μm, and most preferably 2 to 100 μm.

The above-described aluminophosphates (hereinafter appropriately abbreviated as “ALPO”) are crystalline aluminophosphates assigned by the International Zeolite Association (IZA). The atoms that configure the framework structures of crystalline aluminophosphates are aluminium and phosphorous, and other atoms may be substituted for some of those atoms. Among these, in terms of the adsorption characteristic, preferred are: (I) an Me-aluminophosphate where a heteroatom Me1 (where Me1 is at least one type of element that belongs to the third or fourth period of the periodic table and is selected from elements in Group 2A, Group 7A, Group 8, Group 1B, Group 2B and Group 3B (excluding Al)) is substituted for some aluminium; (II) an Me-aluminophosphate where a heteroatom Me2 (where Me2 is a Group 4B element belonging to the third or fourth period of the periodic table) is substituted for phosphorous; or (III) an Me-aluminophosphate where heteroatoms Me1 and Me2 are respectively substituted for both aluminium and phosphate.

One type or two or more types of Me may be included. Preferable Me (Me1, Me2) are elements that belong to the third and fourth period of the periodic table. Me1 preferably has an ionic radius equal to or greater than 0.3 nm and equal to or less than 0.8 nm in a divalent state and more preferably has an ionic radius equal to or greater than 0.4 nm and equal to or less than 0.7 nm in a divalent 4-coordinate state. Among these, in terms of the ease of synthesis and the adsorption characteristic, it is preferable for Me1 to be at least one type of element selected from Fe, Co, Mg and Zn and particularly preferable for Me1 to be Fe. Me2 is a Group 4B element belonging to the third or fourth period of the periodic table and is preferably Si.

Further, as the above-described aluminophosphates, ordinarily aluminophosphates whose framework density (FD) is equal to or greater than 13 T/nm³ and equal to or less than 20 T/nm³ are used. The lower limit of the framework density is preferably equal to or greater than 13.5 T/nm³ and more preferably equal to or greater than 14 T/nm³. The upper limit of the framework density is preferably equal to or less than 19 T/nm³. When the framework density is below the above-described range, there is a tendency for the structure to become unstable and durability drops. When the framework density exceeds the above-described range, the adsorption capacity becomes smaller and the adsorbent becomes unsuitable for use. It will be noted that “framework density” (unit: T/nm³) means the number of T atoms (number of elements configuring the framework other than oxygen per 1 nm³ of a zeolite) present per unit volume (nm³).

Examples of the structures of the aluminophosphates may, when represented by the codes assigned by the IZA, include AEI, AEL, AET, AFI, AFN, AFR, AFS, AFT, AFX, ATO, ATS, CHA, ERI, LEV and VFI. Among these, in terms of the adsorption characteristic and durability, aluminophosphates having an AEI, AEL, AFI, CHA or LEV structure are preferable, and aluminophosphates having an AFI or CHA structure are particularly preferable.

As the adsorbent, among the aluminophosphates such as described above, SAPO-34 and FAPO-5 are particularly preferable. Further, one type or two or more types of ALPO can also be combined and used. It will be noted that the manufacturing conditions of FAPO and SAPO are not particularly limited, and ordinarily FAPO and SAPO are manufactured by mixing together, and thereafter hydrothermally synthesizing, an aluminium source, a phosphorous source, an ME source such as Si or Fe as needed, and a template. Further, ALPO can be synthesized utilizing publicly known synthesizing methods described in, for example, JP-A No. 1-57041, JP-A No. 2003-183020 and JP-A No. 2004-136269.

In this connection, adsorbents suitable for the dehumidifying/humidifying device of the present invention, such as, for example, crystalline silicoaluminophosphate (SAPO-34), have an adsorption characteristic such as represented by the solid line in FIG. 7 where, in a water vapor adsorption isotherm of 25° C., the adsorption amount drastically changes between a relative humidity of 2% and a relative humidity of 25%, and the difference (δ₁) thereof is equal to or greater than 0.15 g/g. In contrast, conventional absorbents, such as, for example, A-type silica gel or activated carbon, have an adsorption characteristic such as represented by the dotted line in FIG. 7 where, in a water vapor adsorption isotherm of 25° C., the change in the adsorption amount is small between a relative humidity of 2% and a relative humidity of 25%, and the difference (δ₂) thereof is about ½ of or less than that of SAPO-34. That is, the adsorbent applied in the present invention has the characteristic that the adsorbent adsorbs and desorbs more water in a low humidity range.

Further, in the present invention, it is preferable for an aeration area (total opening area orthogonal to an aeration direction of the element (33)) of each of the first adsorbing element (31) and the second adsorbing element (32) to be set to be equal to or greater than a minimum cross-sectional area (opening area orthogonal to aeration direction) of flow paths on an upstream side and a downstream side of the adsorbent module (3). Specifically, the first adsorbing element (31) and the second adsorbing element (32) may be formed in a width that is larger than the width of the portion of the casing that houses the blowers (2) and the flow path switching units (4). Further, the first adsorbing element (31) and the second adsorbing element (32) may be formed thicker than the thickness of the portion of the casing that houses the blowers (2) and the flow path switching units (4). When the aeration area of the adsorbing elements (31) and (32) is set as described above, the flow velocity of the air passing through the insides of the adsorbing elements (31) and (32) can be reduced, and the adsorbing and desorbing functions of the adsorbing elements (31) and (32) can be further raised.

Further, in the dehumidifying/humidifying device of the present invention, in order to facilitate maintenance, the adsorbing elements (31) and (32) of the adsorbent module (3) are configured such that they are replaceable. Specifically, the adsorbent module (3) is housed in the casing in a state where the adsorbing elements (31) and (32) are tightly adhered, but without being fixed, to the Peltier element (30). Additionally, the adsorbing elements (31) and (32) are configured such that they are removable by opening a cover (not shown) disposed on the casing. Thus, just the adsorbing elements (31) and (32) can be replaced when their adsorption capability has dropped or the like.

In the dehumidifying/humidifying device of the present invention, dehumidified air and humidified air are continuously blown out while alternately switching between the adsorbing operation and the desorbing operation in the adsorbing elements (31) and (32) of the adsorbent module (3). Moreover, air is always blown in different directions in the two air flow paths. Thus, in the present invention, as shown in FIG. 1, the first flow path switching unit (4a) and the second flow path switching unit (4b) that serve as switching mechanisms of the two air flow paths are disposed on the upstream side and the downstream side of the adsorbent module (3).

As the switching mechanisms of the two air flow paths, there can be used a mechanism that causes two flexible conduits to move to change their connection destinations, a mechanism that alternately opens and closes two shutters synchronously actuated by a link or the like to change their connection destinations, or a mechanism that causes two coaxial rotary shutters that are adjacent and, when seen from the side, orthogonal to each other to rotate 90 degrees at a time to change their connection destinations, but from the standpoint of simplifying the device configuration and making the device compact, there are used the flow path switching units (4) that switch the application destination of each of the air flows with a damper (44) that is rotated by an actuator (45). The first flow path switching unit (4a) and the second flow path switching unit (4b) have identical structures except that they are disposed in a symmetrical orientation centered about the adsorbent module (3).

To specifically describe the structure of the flow path switching units (4), for example, the second flow path switching unit (4b) is, as shown in FIGS. 4A and 4B, configured by disposing, inside a box body that configures the outer contour of the flow path switching unit, an upper first introduction chamber (41) into which flows air that has passed through the adsorbent module (3), a lower second introduction chamber (42) into which flows air that has been blown from the second blower (2b), a directing chamber (43) between these introduction chambers (41) and (42), a damper (44) that switches the flow of air, and an actuator (45) that actuates the damper.

As shown in FIGS. 4A and 4B and FIG. 5A, air inlet/outlets (51) and (52) into which air flows or from which air flows out are disposed in the front end (the end portion on the left side of FIGS. 4A and 4B) of the box body of the second flow path switching unit (4b), and a blow-out opening (81) that blows out directed air and a blow-in opening (82) that takes in air supplied from the blower (2b) are disposed in the back end (the end portion on the right side of FIGS. 4A and 4B) of the box body. Additionally, the inside of the box body is partitioned front and back by a partition wall (15) along the flow direction of the air (see FIGS. 4A and 4B), and the first introduction chamber (41), the second introduction chamber (42) and the directing chamber (43) are formed by vertically partitioning, into three levels by two partition plates (16) and (17), the space on the upstream side (the adsorbent module (3) side) of the partition wall (15) (see FIG. 4B and FIG. 5A).

The first introduction chamber (41) is, as shown in FIG. 4B and FIG. 5A, configured such that air that has passed through the first adsorbing element (31) of the adsorbent module (3) flows in through the inlet/outlet (51) disposed in the upper portion of the front end (the end portion on the left side of FIGS. 4A and 4B) of the box body and is configured to supply air to the first adsorbing element (31). The second introduction chamber (42) is configured to supply air to the second adsorbing element (32) of the adsorbent module (3) through the inlet/outlet (52) disposed in the lower portion of the front end (the end portion on the left side of FIGS. 4A and 4B) of the box body and is configured such that air that has passed through the second adsorbing element (32) flows in.

The directing chamber (43) is a space that functions cooperatively with the damper (44) to direct the outflow destinations and the introduction destinations of the air and, as shown in FIG. 4B and FIG. 5A, is disposed between the first introduction chamber (41) and the second introduction chamber (42). Additionally, as shown in FIGS. 6A and 6B, aeration holes (61) and (62) are respectively disposed in the centers of the two partition plates (16) and (17), and these aeration holes (61) and (62) serve as inlet/outlets of air to the directing chamber (43). Further, a blow-out hole (71) and a blow-in hole (72) are respectively disposed to the left and right of a portion of the partition wall (15) that corresponds to the height of the directing chamber (43), and the blow-out hole (71) and the blow-in hole (72) serve as inlet/outlets of air with respect to the directing chamber (43).

That is, the first aeration hole (61) and the second aeration hole (62) that are respectively communicated with the introduction chambers (41) and (42) are disposed in the directing chamber (43) and are configured such that air in the introduction chambers (41) and (42) flows in and such that air flows out to the introduction chambers (41) and (42). Additionally, the blow-out hole (71) and the blow-in hole (72) that are respectively communicated with the blow-out opening (81) and the blow-in opening (82) are disposed in the directing chamber (43) and are configured such that air in the directing chamber (43) flows out to the blow-out opening (81) and such that air supplied from the blow-in opening (82) is introduced to the directing chamber (43).

The damper (44) is, as shown in FIGS. 4A and 4B, FIG. 5A and FIGS. 6A and 6B, disposed in the center of the directing chamber (43), or in other words between the aeration holes (61) and (62), and is configured such that it can rotate a certain angle about an axis orthogonal to a front end surface of the box body and a plate surface of the partition plate (15). The damper (44) is actuated by the actuator (45), which is disposed on the opposite side (the downstream side) of the directing chamber (43) with respect to the partition wall (15), and the damper (44) can partition the directing chamber (43) into two spaces as a result of the left and right side edges of the damper contacting the partition plates (16) and (17). It will be noted that, as the actuator (45), ordinarily a geared type stepping motor is used because it can cause the damper (44) to forwardly and inversely rotate a certain angle.

The directing chamber (43) is configured to partition the inside of the box body (the inside of the second flow path switching unit (4b)) into a space (8a) that includes the aeration hole (61) and the blow-out hole (71) and a space (8b) that includes the aeration hole (62) and the blow-in hole (72) as shown in FIG. 6A as a result of the damper (44) rotating in one direction and to partition the inside of the box body (the inside of the second flow path switching unit (4b)) into a space (9a) that includes the aeration hole (61) and the blow-in hole (72) and a space (9b) that includes the aeration hole (62) and the blow-out hole (71) as shown in FIG. 6B as a result of the damper (44) rotating in the other direction.

The first flow path switching unit (4a) and the second flow path switching unit (4b) are disposed such that the inlet/outlets (51) and (52) (see FIGS. 5A and 5B) are respectively adjacent to aeration surfaces (surfaces that the element (33) expose) of the first adsorbing element (31) and the second adsorbing element (32) of the adsorbent module (3). That is, as shown in FIG. 1, the first flow path switching unit (4a) and the second flow path switching unit (4b) are, as mentioned before, disposed with their fronts and backs turned the other way around, with the adsorbent module (3) being interposed therebetween.

Because of the structures of the flow path switching units (4) shown in FIG. 4A to FIG. 6B and the above-described arrangement of the flow path switching units (4), as shown in FIG. 1, the first flow path switching unit (4a) is configured to be capable of applying air that has been blown from the first blower (2a) to the first adsorbing element (31) (or the second adsorbing element (32)) of the adsorbent module (3) and introducing, and applying to the second blow-out opening (12), air that has passed through the second adsorbing element (32) (or the first adsorbing element (31)). Moreover, the first flow path switching unit (4a) is configured to be capable of switching the application destination of air that has been blown from the first blower (2a) and the introduction destination of air that is to be applied to the second blow-out opening (12).

Further, because of the above-described structures and arrangement of the flow path switching units (4), the second flow path switching unit (4b) is configured to be capable of introducing, and applying to the first blow-out opening (11), air that has passed through the first adsorbing element (31) (or the second adsorbing element (32)) of the adsorbent module (3) and applying air that has been blown from the second blower (2b) to the second adsorbing element (32) (or the first adsorbing element (31)). Moreover, the second flow path switching unit (4b) is configured to be capable of switching the introduction destination of air that is to be applied to the first blow-out opening (11) and the application destination of air that has been blown from the second blower (2b).

The dehumidifying/humidifying device of the present invention is, in order to continuously blow out air that has been dehumidified and air that has been humidified, configured to blow out air that has been dehumidified (or humidified) from the first blow-out opening and blow out air that has been humidified (or dehumidified) from the second blow-out opening by inverting an electric current flowing through the Peltier element in the adsorbent module to interchange the heat absorbing component and the heat releasing component of the Peltier element and switching the first flow path switching unit and the second flow path switching unit in response to the inversion of the electric current. It will be noted that, although it is not shown, the dehumidifying/humidifying device of the present invention is configured to use a separately disposed control unit to perform control of the rotation of each of the blowers (2), control of the electric current in the Peltier element (30) and control of the actuation of each of the flow path switching units (4).

The dehumidifying/humidifying device of the present invention operates as described below in winter when the outside air is dry, for example. That is, the first blower (2a) sucks in the air inside the cabin from the first suction opening (the left side of FIG. 1) in the casing and blows this air to the first flow path switching unit (4a). Initially the damper in the first flow path switching unit (4a) is in a position where it has rotated in the one direction, and the first flow path switching unit (4a) guides the in-blown air to the first adsorbing element (31) of the adsorbent module (3). The first adsorbing element (31) contacts the one plate surface (3a) of the Peltier element (30) that is in a cooled state because of control of the electric current (control of the applied direction of the electric current) by the control unit and is cooled to a low temperature. Consequently, the adsorbent carried in the first adsorbing element (31) exhibits an adsorbing function and removes water vapor from the air passing through the element (33). Additionally, when the dehumidified air that has been obtained as a result of air passing through the first adsorbing element (31) is blown to the second flow path switching unit (4b), the damper of the second flow path switching unit (4b) is in a position where it has rotated in the one direction, and the second flow path switching unit (4b) guides the inflowing air to the blow-out opening (81). As a result, the air that has been dehumidified is blown out from the first blow-out opening (11) (the right side of FIG. 1) in the casing.

Meanwhile, the second blower (2b) sucks in the air inside the cabin from the second suction opening (the right side of FIG. 1) in the casing and blows this air to the second flow path switching unit (4b). The damper in the second flow path switching unit (4b) is, as described above, in a position where it has rotated in the one direction, and the second flow path switching unit (4b) guides the in-blown air to the second adsorbing element (32) of the adsorbent module (3). The second adsorbing element (32) contacts the other plate surface (3b) of the Peltier element (30) that is in a heated state because of control of the electric current (control of the applied direction of the electric current) by the control unit and is heated to a high temperature. Consequently, the adsorbent carried in the second adsorbing element (32) exhibits a desorbing function and releases water vapor into the air passing through the element (33). Additionally, when the humidified air that has been obtained as a result of air passing through the second adsorbing element (32) is blown to the first flow path switching unit (4a), the damper of the first flow path switching unit (4a) is, as described above, in a position where it has rotated in the one direction, and the first flow path switching unit (4a) guides the inflowing air to the blow-out opening (81). As a result, the air that has been humidified is blown out from the second blow-out opening (12) (the left side of FIG. 1) in the casing.

Next, in the adsorbent module (3), when the above-described adsorbing and desorbing operations are performed for a certain amount of time, such as 30 to 1800 seconds, for example, the applied direction of voltage with respect to the Peltier element (30) is switched by circuit control by the control unit. That is, in the adsorbent module (3), the one plate surface (3a) of the Peltier element (30) is heated and the other plate surface (3b) is cooled. Moreover, in accompaniment with the switching of the applied direction of voltage with respect to the Peltier element (30), the dampers (44) of the flow path switching units (4) are switched by control of the actuation of the actuators (45) by the control unit. In the first flow path switching unit (4a), the damper is switched to a position where it has rotated in the other direction and, simultaneously, in the second flow path switching unit (4b) also, the damper is switched to a position where it has rotated in the other direction.

When the energization state with respect to the Peltier element (30) in the adsorbent module (3) and the flow paths in the flow path switching units (4) are switched as described above, air that has been blown from the first blower (2a) is guided to the second adsorbing element (32) of the adsorbent module (3) by the first flow path switching unit (4a). The second adsorbing element (32) is cooled to a low temperature by the Peltier element (30), so the adsorbent carried therein exhibits an adsorbing function and removes water vapor from the air passing through the element (33). Additionally, the obtained dehumidified air is guided to the blow-out opening (81) by the second flow path switching unit (4b) and is blown out from the first blow-out opening (11) in the casing.

Meanwhile, air that has been blown from the second blower (2b) is guided to the first adsorbing element (31) of the adsorbent module (3) by the second flow path switching unit (4b). The first adsorbing element (31) is heated to a high temperature by the Peltier element (30), so the adsorbent carried therein exhibits a desorbing function and releases water vapor into the air passing through the element (33). Additionally, the obtained humidified air is guided to the blow-out opening (81) by the first flow path switching unit (4a) and is blown out from the second blow-out opening (12) in the casing.

In the dehumidifying/humidifying device of the present invention, the adsorbing and desorbing operations in the first adsorbing element (31) and the adsorbing and desorbing operations in the second adsorbing element (32) of the adsorbent module (3) described above are reversed at a constant timing, and, in response thereto, the flow paths of the air that has been dehumidified and the air that has been humidified are switched by the first flow path switching unit (4a) and the second flow path switching unit (4b). Thus, the air that has been dehumidified can be continuously blown out from the first blow-out opening (11), for example, and the air that has been humidified can be continuously blown out from the second blow-out opening (12). Additionally, the dehumidified air can be used for defogging a window and the humidified air can be used for improving comfort. It will be noted that, in the present invention, as the method of controlling the electric current in the Peltier element (30) and controlling the actuation of the flow path switching units (4), various methods, such as a method that switches in response to the humidity inside the cabin detected by a humidity sensor, can be used.

As described above, in the dehumidifying/humidifying device of the present invention, the adsorbent module (3) is configured by the fixed pair of adsorbing elements (31) and (32) and the Peltier element (30), the adsorbing operation and the desorbing operation of the adsorbing elements (31) and (32) are reversed by the inversion of the electric current flowing to the Peltier element (30), and the flows of the dehumidified air and the humidified air are switched by the flow path switching units (4a) and (4b), and thus, the dehumidified air, for example, is continuously flown out from the first blow-out opening (11) and the humidified air, for example, is continuously blown out from the second blow-out opening (12), so it is not necessary to disposed a rotary member drive mechanism as in a conventional adsorption rotor, and, moreover, the adsorbing elements (31) and (32) are directly disposed on the plate surfaces (3a) and (3b) of the Peltier element (30) that function as a heat absorbing component and a heat releasing component, and heat conductivity between the Peltier element (30) and the adsorbing elements (31) and (32) is high, so thermal efficiency is excellent, and the adsorbent module (3) can be made even more compact. Additionally, the device configuration can be simplified and the device overall can be made even more compact.

Further, in the dehumidifying/humidifying device of the present invention, the flows of air are respectively inverted in the first adsorbing element (31) and the second adsorbing element (32) as a result of the adsorbing and desorbing operations being switched in the adsorbent module (3), so the performance of the adsorbent can be sufficiently exhibited across the entire lengths of the adsorbing elements (31) and (32). Moreover, the flows of the air that has been dehumidified and the air that has been humidified are in different directions, and the first blow-out opening (11) and the second blow-out opening (12) can be disposed in positions away from each other, such as in both ends of the casing, so the degree of freedom of arrangement inside the vehicle can be improved depending on the purpose.

Moreover, in the dehumidifying/humidifying device of the present invention, the adsorbing elements (31) and (32) of the adsorbent module (3) are configured such that they are replaceable, so that when their adsorption capability drops because of clogging or the adsorption of substances other than water vapor, the device performance can be restored by removing the adsorbent module (3) from the casing and replacing just the adsorbing elements (31) and (32). Further, by replacing the adsorbing elements (31) and (32) in units of several years, for example, without using a filter, the device can be maintained over a long period of time, and maintenance costs can also be reduced.

It will be noted that examples of substances other than water vapor may include odorous substances such as 13 VOC substances (formaldehyde, acetaldehyde, toluene, xylene, ethylbenzene, styrene, paradichlorobenzene, tetradecane, di-n-butyl phthalate, di-(2-ethylhexyl)phthalate, diazinone, fenobucarb, chlorpyrifos), acetic acid, fatty acids (n-butyric acid), amines and ammonia, but when the adsorbing elements (31) and (32) are configured such that they are replaceable as described above, the aforementioned odorous substances and the like that have become concentrated when the inside of the cabin has reached a high temperature can be prevented from being rereleased inside the cabin.

Further, although it is not shown, in the dehumidifying/humidifying device of the present invention, in order to blow out more comfortable air toward the passenger, there may also be disposed a heat exchanger that performs sensible heat exchange between air that has been dehumidified (or humidified) by the first adsorbing element (31) of the adsorbent module (3) and air that has been humidified (or dehumidified) by the second adsorbing element (32). For example, although the humidified air that is blown out toward the passenger from the second blow-out opening (12) is air including water that has been desorbed in the adsorbent module (3), there are also cases where the humidified air needlessly reaches a high temperature due to heat at the time of thermal desorption. On the other hand, the dehumidified air that is blown out toward the window from the first blow-out opening (11) reaches a low temperature because it passes through the adsorbing elements (31) and (32) that have been cooled. Thus, the present invention is configured such that a heat exchanger is disposed on the upstream side and the downstream side of the adsorbent module (3), so that the temperature of the humidified air is lowered and the temperature of the dehumidified air is raised by these heat exchangers.

As the above-described heat exchangers, there can be used various types of heat exchangers such as sensible heat exchangers such as a block-shaped sensible heat exchanger that comprises a metal with high thermal conductivity such as aluminium and includes numerous fins on its surface and an orthogonal heat exchanger that includes plural parallel flat plates comprising the same metal as described above and causes high-temperature air and low-temperature air to flow adjacently in mutually adjacent gaps between the flat plates. When the above-described heat exchangers are disposed, heat exchange can be performed between humidified air whose temperature is high and dehumidified air whose temperature is low, so that in winter, for example, comfortable air that has been humidified and whose temperature has dropped moderately can be blown out toward the passenger.

Moreover, it is preferable for the heat exchangers to be disposed on the downstream sides of the flow path switching units (4). When heat exchangers are disposed on the downstream sides of the flow path switching units (4), in comparison to when the heat exchangers are disposed between the adsorbent module (3) and the flow path switching units (4), there is no interchanging of the flow paths of the high-temperature air and the low-temperature air and there is no heat loss in the heat exchangers themselves, so heat exchange can be done efficiently and the temperature of the humidified air that is to be blown out toward the passenger can be lowered.

Further, in the present invention, in order to lower the temperature of the humidified air that is blown from the adsorbent module (3) and raise the temperature of the humidified air, a heater/cooler that utilizes a Peltier element may be disposed on the upstream side and the downstream side of the adsorbent module (3) (in front of and in back of the adsorbent module (3)). The heater/cooler is configured by: a Peltier element equipped with a pair of plate surfaces that respectively function as a heat absorbing component and a heat releasing component; and a first heat exchange element and a second heat exchange element, each of which is equipped with an aeratable element for heat exchange, that are disposed on the plate surfaces of the Peltier element. As the structure of the element of each of the first and second heat exchange elements, similar to the structure of the element in the adsorbing elements (31) and (32), a corrugated, honeycomb or lattice structure can be used.

In the dehumidifying/humidifying device of the present invention, when the above-described heater/coolers are used, the temperature of the humidified air that is blown out from the adsorbent module (3) can be reliably lowered and the temperature of the dehumidified air can be reliably raised by switching the electric current in the Peltier element synchronously with the switching operation of the adsorbent module (3) to switch between heating and cooling in the first heat exchange element and the second heat exchange element. Further, the temperatures of the humidified air and the dehumidified air can be adjusted by controlling the electric current in the Peltier element.

It will be noted that, in the above-described embodiment, although the dehumidifying/humidifying device is configured to blow out air that has been dehumidified from the first blow-out opening (11) and to blow out air that has been humidified from the second blow-out opening (12), the dehumidifying/humidifying device may also be configured to blow out air that has been humidified from the first blow-out opening (11) and to blow out air that has been dehumidified from the second blow-out opening (12) by reversing control of the electric current in the Peltier element (30) of the adsorbent module (3). Thus, for example, in summer, when the outside air becomes humid, dehumidified air can be blown out toward the passenger to improve the comfort inside the cabin.

Further, in the dehumidifying/humidifying device of the present invention, a deodorization filter may be disposed on the upstream side or the downstream side of the adsorbent module (3) in order to trap odorous components in the cabin. Moreover, the shape and arrangement of the flow paths, the disposed configuration of the adsorbent module (3) and the arrangement of the blowers (2) are not limited to the structures shown in the drawings and can be appropriately designed as long as they do not compromise the functions of these.

### INDUSTRIAL APPLICABILITY

The present invention is widely applicable to vehicles in general as a vehicle dehumidifying/humidifying device that supplies dehumidified air for defogging to a window of a vehicle and supplies humidified air to a passenger.

### EXPLANATION OF THE REFERENCE NUMERALS

11: First Blow-Out Opening
12: Second Blow-Out Opening
2: Blowers
2a: First Blower
2b: Second Blower
3: Adsorbent Module
30: Peltier Element
31: Adsorbing Element
32: Adsorbing Element
33 Element
4: Flow Path Switching Units
4a: First Flow Path Switching Unit
4b: Second Flow Path Switching Unit
41: Introduction Chamber
42: Introduction Chamber
43: Directing Chamber
44: Damper
45: Actuator

1. A vehicle dehumidifying/humidifying device that dehumidifies and humidifies air inside a vehicle cabin, the vehicle dehumidifying/humidifying device being configured by sequentially housing a first blower, a first flow path switching unit, an adsorbent module, a second flow path switching unit and a second blower in a casing that serves as an air flow path in which a first suction opening, a second suction opening, a first blow-out opening and a second blow-out opening are disposed,
wherein
the adsorbent module is configured by
a Peltier element equipped with a pair of plate surfaces that respectively function as a heat absorbing component and a heat releasing component and
a first adsorbing element and a second adsorbing element, each of which comprises an adsorbent carried in an aeratable element, that are respectively directly disposed on the plate surfaces of the Peltier element
and the adsorbent module is disposed inside the casing such that flows of air blown by the blowers are respectively capable of passing in parallel through the first adsorbing element or the second adsorbing element,
the first flow path switching unit is configured to be capable of applying air that has been blown from the first blower to the first adsorbing element or the second adsorbing element of the adsorbent module and introducing, and applying to the second blow-out opening, air that has passed through the second adsorbing element or the first adsorbing element and is configured to be capable of switching the
application destination of air that has been blown from the first blower and the introduction destination of air that is to be applied to the second blow-out opening,
the second flow path switching unit is configured to be capable of introducing, and applying to the first blow-out opening, air that has passed through the first adsorbing element or the second adsorbing element of the adsorbent module and applying air that has been blown from the second blower to the second adsorbing element or the first adsorbing element and is configured to be capable of switching the introduction destination of air that is to be applied to the first blow-out opening and the application destination of air that has been blown from the second blower, and
the vehicle dehumidifying/humidifying device is configured to blow out air that has been dehumidified or humidified from the first blow-out opening and blow out air that has been humidified or dehumidified from the second blow-out opening by inverting an electric current flowing through the Peltier element in the adsorbent module to interchange the heat absorbing component and the heat releasing component of the Peltier element and switching the first flow path switching unit and the second flow path switching unit in response to the inversion of the electric current.

2. The vehicle dehumidifying/humidifying device of claim 1, wherein the first adsorbing element and the second adsorbing element of the adsorbent module are configured such that they are respectively replaceable.

3. The vehicle dehumidifying/humidifying device of claim 1, wherein the element of each of the first adsorbing element and the second adsorbing element is a corrugated element formed by stacking a plurality of honeycomb sheets, each of which comprises a substantially corrugated base material sheet and a substantially flat base material sheet, and the element has a structure where the substantially flat base material sheet of each of the honeycomb sheets is disposed parallel to the plate surfaces of the Peltier element.

4. The vehicle dehumidifying/humidifying device of claim 1, wherein the element of each of the first adsorbing element and the second adsorbing element is a corrugated element formed by stacking a plurality of honeycomb sheets, each of which comprises a substantially corrugated base material sheet and a substantially flat base material sheet, and the element has a structure where the substantially flat base material sheet of each of the honeycomb sheets is disposed orthogonal to the plate surfaces of the Peltier element.

5. The vehicle dehumidifying/humidifying device of claim 1, wherein the adsorbent is a crystalline aluminophosphate including at least Al and P in a framework structure.

6. The vehicle dehumidifying/humidifying device of claim 1, wherein each of the flow path switching units is configured to switch the application destination of each of the flows of air with a damper that is actuated by an actuator.

7. The vehicle dehumidifying/humidifying device of claim 1, wherein a heat exchanger that performs sensible heat exchange between air that has been dehumidified or humidified by the first adsorbing element of the adsorbent module and air that has been humidified or dehumidified by the second adsorbing element is disposed on an upstream side and a downstream side of the adsorbent module.

8. The vehicle dehumidifying/humidifying device of claim 1, wherein a total opening area orthogonal to an aeration direction of the adsorbing elements of the adsorbent module is equal to or greater than a minimum opening cross-sectional area orthogonal to an aeration direction of upstream side and downstream side flow paths of the adsorbent module.
